(19) United States
(12) Patent Application Publication
(10) Pub. No.: US 2005/0165630 A1
(43) Pub. Date: Jul. 28, 2005

(54) Computer-based planning and control system for companies that manufacture and market products

(76) Inventors: William Harry Hoffman, Chippewa Falls, WI (US); Roland James Hron, Altoona, WI (US)

Correspondence Address: William H. Hoffman, 604 W Central St., Chippewa Falls, WI, 54729, US

(21) Appl. No.: 10/765,736

(22) Filed: Jan. 28, 2004

(51) Int. Cl. G06F 17/60

(52) U.S. Cl. 705/7

(57) ABSTRACT

CBBS forecasts and plans production, with minimum throughput time, of product in units that the company advertises for sale and sells those units before, during, or after production. The principle advantage that CBBS has compared to ERP is that CBBS fills customer orders without need to expedite component shortages and without last-minute production scheduling and rescheduling. CBBS monitors incoming sales for each product versus forecast and detects when forecasts should be reviewed to keep forecasts in line with incoming sales. CBBS also detects when inventory of a product that is forecast rises above a prescribed level (which may be zero) for the product, indicating that the forecast may need to be adjusted down.

### BACKGROUND OF THE INVENTION

Presently, the computer-based planning and control systems serving the the needs of companies who manufacture and market products are known as Enterprise Resource Planning (ERP) systems.

ERP systems have been sold on the basis of providing the cabability to help companies forecast sales, plan procurement and production, improve their performance, and work toward the following examples of high performance goals within their industry:
Shortest lead times to their customers
Best on-time delivery performance to customers
Highest inventory turns
Highest net profit as a % of sales revenues
Highest return on investment

While ERP systems have been partially successful, this patent application will show how the features designed into CBBS will provide companies the capability to achieve higher levels of performance than they have using ERP.

### BRIEF SUMMARY OF THE INVENTION

1. CBBS forecasts and plans production, with minimum throughput time, of product in units that the company advertises for sale and sells those units before, during, or after production. The principle advantage that CBBS has compared to ERP is that CBBS fills customer orders without need to expedite component shortages and without last-minute production scheduling and rescheduling.

2. CBBS monitors incoming sales for each product versus forecast and detects when forecasts should be reviewed to keep forecasts in line with incoming sales. CBBS also detects when inventory of a product that is forecast rises above a prescribed level (which may be zero) for the product, indicating that the forecast may need to be adjusted down.

### DETAILED DESCRIPTION OF THE INVENTION

1. CBBS-starts with an average forecast/workday (Fst), typically two decimal places, for a product to be sold. The Fst can then be modified between designated dates as it is extended (typically) two years into the future. CBBS maintains the planning period by adding a workday each day.

The forecast product may be a complete unit ready for sale or it may entail any number of Features. (“Feature” and “Option” are synonymous herein). Each Feature (FE) has a Fst proportional to the Fst of the product with which it is associated. Rules for selecting features at point of sale are designed into the order entry routine.

2. Each product forecast (example: BAS1) has a Standard Sales Quantity (StdSlsQty) and is planned using its StdQty which is an integral multiple of its StdSlsQty. In the illustration to follow, BAS1: Fst=1.23, StdSlsQty=1, StdQty=6, beginning Bal (inventory)=3. A feature (FE1) may be used, for example, in quantities of 3 per BAS1. Its StdQty for planning purposes would be 18 (3×6) unless an integral multiple >1 were chosen. FE1 is ordered with an estimated 40% of BAS1s sold.

| Day# | 0 | 1 | 2 | 3 | 4 | 5 | 6 | 7 | 8 | 9 |
|---|---|---|---|---|---|---|---|---|---|---|
| Fst BAS1 | | 1.23 | 1.23 | 1.23 | 1.23 | 1.23 | 1.23 | 1.23 | 1.23 | 1.23 |
| StdQty BAS1 | | | | 6 | | | | | 6 | |
| Bal BAS1 | 3 | 1.77 | .54 | 5.31 | 4.08 | 2.85 | 1.62 | .39 | 5.16 | 3.93 |
| Fst FE1 | | | | 7.20 | (1) | | | | 7.20 | |
| StdQty FE1 | | | | 18 | | | | | | |
| Bal FE1 | 0 | | | 10.80 | | | | | 3.60 | |

| | |
|---|---|
| (1) | 3 × 6 × .40 = 7.20 |

3. The commonly accepted way of engineering and structuring a product is its Bill Of Material (BOM). The top level (level 0) of the BOM is a Make Part. The next level, down (level 1) on the BOM shows the Make Parts and the Buy Parts used in making the level 0 Make Part. Level 1 must have at least one Part, but otherwise may have any number of Make Parts or Buy Parts. If there is a Make Part at level 1, level 2 under that Make Part shows the Parts needed. This logic continues to the final level where there are only Buy Parts.

Every Make Part has a Routing (Rtg) which contains a series of operations (Ops) required to make it. Each Op shows the Work Center (WrkCtr) where it is performed, the Setup and Run (per unit) time standards to perform the Op.

Unique to CBBS:

Days (to three decimal places) required to complete the Setup and Run for a StdQty are calculated.
Each Part on a BOM (except the Make Part at level 0) in CBBS is keyed to the Op on the Rtg for the Make Part where it is used, thus enabling CBBS to schedule the arrival of the Part to coincide with the start of that Op.

StdQtys are prescheduled with feasible overlap of Ops and this prescheduling is duplicated in actual production. The result of this programmed logic is illustrated starting on page 6:

| | | | | | StdQty = 12 | |
|---|---|---|---|---|---|---|
| | | | Hours | | Days (1) | |
| | OpSeq | WrkCtr | Setup | Run/unit | Setup | Run |
| 10 | P41 | 1.00 | .75 | .089 | .804 | |
| 20 | A17 | .50 | 2.30 | .045 | 2.464 | |
| 30 | F12 | .75 | .68 | .067 | .729 | |

| | Schedule - Days in tenths |
|---|---|
| Op | 0 2 4 6 8 10 12 14 16 18 20 22 24 26 28 |
| 10 | ----------------------- |

| | |
|---|---|
| 20 | -------------------------------------------------------------------- |

| | |
|---|---|
| 30 | --------------------------- |

Since Op10 is <Op20 in Days, Op20 can be started after Op10 Setup+Run one unit. (2)
Since Op20 is >Op30 in Days, Op30 can be finished one unit after Op20 is finished. (3)
   (1) Calculations for Setup and Run Days:

Factors:
Productivity Factor for WrkCtrs=.70
Day Length in hours for WrkCtrs=16
StdQty=12
Setup for Op10: 1.00/.70/16=.089 Days
Setup for Op20: .50/.70/16=.045 Days
Setup for Op30: .75/.70/16=.067 Days
Run for Op10: 12×.75/.70/16=.804 Days
Run for Op20: 12×2.30/.70/16=2.464 Days
Run for Op30: 12×.68/.70/16=.729 Days
   (2) in Days: (1.00+.75)/.70/16=.156 Days
   (3) In Days: .68/.70/16=.061 Days

4. Since CBBS is designed to preschedule product that is advertised for sale and then to sell that product, it is important that forecasts, which are the basis of the prescheduling, be continually monitored against incoming sales to signal when actual demand is falling significantly above or below forecast.

While other time periods are feasible, CBBS chooses to each day compare incoming sales versus cumulative Fst for the prior 62 workdays, which normally represents a quarter of a year. The 62 days is adjusted, on any day if necessary, to include one and only one final day of a quarter. The selection of a quarter as a time period allows fluctuations in sales, such as those caused by “end-of-quarter-push”, to average out. If incoming sales deviates from the cumulative Fst more than d %, where d=parameter for the Part or class of Parts, the Fst is flagged for review.

CBBS also monitors inventory level of a Fst Part and flags it for review when Inventory>ix(StdSlsQty), where i=parameter for the Part or class of Parts (i can=0).

5. When Fsts are changed, replanning of all Parts affected and rescheduling of all Make Parts affected is executed in a matter of seconds. Current delivery schedules are always online to suppliers. Current production schedules are always online for the Company's manufacturing managers and subcontractors.

1. A unique system of planning and executing production (both with the same minimum time span) of products in Standard Sales Quantities
starting with an average quantity per day to two or more decimal places,
automatically modifying that quantity per day through time,
automatically converting the quantity per day to a series of Standard Sales Quantities with variable spans of time between Quantities but whose average over a long period of time equals that of the modified quantities per day,
selling Standard Sales Quantities still in the planned stage, Quantities in production, or Quantities from inventory.
